(19) United States
(12) Patent Application Publication
(10) Pub. No.: US 2004/0249544 A1
(43) Pub. Date: Dec. 9, 2004

(54) Wheel speed sensor arrangement with transmission of additional information

(76) Inventor: Peter Lohberg, Friedrichsdorf (DE)

Correspondence Address: Gerlinde M Nattler, Continental Teves Inc, One Continental Drive, Auburn Hills, MI, 48326, US

(21) Appl. No.: 10/477,303

(22) PCT Filed: May 6, 2002
(86) PCT No.: PCT/EP02/04945

(30) Foreign Application Priority Data
May 10, 2001 (DE) 101 22 807.4
Jan. 30, 2002 (DE) 102 03 483.4

(51) Int. Cl. G01P 3/44; G06F 19/00

(52) U.S. Cl. 701/70; 73/531; 702/145

(57) ABSTRACT

The present invention relates to an arrangement comprising a wheel speed sensor (1) and a control device (ECU), wherein the wheel speed sensor is connected to the control device by way of a data interface (k1, k2, k3, k4), wherein the wheel speed sensor includes means for sending rotational speed information in signal channels (t2 . . . t10) and each piece of information is associated with a signal channel and/or a fixed number of signal channels. Further, the wheel speed sensor comprises switch-over means (10, 11) enabling modification of the allocation of the additional information to the available channels by mode switch-over.

### BACKGROUND OF THE INVENTION

The present invention relates to an arrangement including at least one wheel speed sensor (1) and at least one control device (ECU), wherein the at least one wheel speed sensor is connected to the control device by way of a data interface (k1,k2,k3,k4) preferably composed of two electric current paths and used to transmit wheel speed information and additional information, wherein the wheel speed sensor includes means for sending rotational speed information via the data interface and means for sending additional information, and wherein the sensor includes a predetermined, however, optionally variable number of signal channels (t2 . . . t10) for the transmission of the additional information via the interface and each piece of information is allocated to a signal channel and/or a fixed number of signal channels. It also relates to a wheel speed sensor for this arrangement, and a control device for this arrangement

International patent application WO 98/09173 discloses an active wheel speed sensor for transmitting the rotational speed information of a motor vehicle wheel to the electronic control device of a brake system. By way of a current interface, the wheel speed signal is transmitted to the control device in the shape of square-wave pulses having intervals that decrease at rising rotational speed. The current transmitted by way of the interface additionally represents the electric energy supply for the active sensor so that only two conduits are required to connect the sensor and the control device. The sensor comprises a device that permits transmitting, apart from the wheel speed signal, also additional information required for the anti-lock system, for example information about brake lining wear, the direction of rotation, or the air gap.

In these prior-art wheel speed sensors the wheel rotational speed is transmitted in the form of square-wave pulses, the interval between the pulses being an indicator of the rotational speed. It has been found out that the above-described sensor arrangement suffers from the disadvantage that with increasing driving speed or wheel rotational speed, the number of additional transmittable information will be reduced due to a decreasing pulse-pause length and a related number of channels reducing channel-wise or bit-wise.

The wheel rotational speed in passenger vehicles with anti-lock systems is typically detected by means of magnet sensors, which are in interaction with rotating encoders attached to the wheel bearing. When, for example, in a usual series configuration of a system of this type the wheel circumference amounts to 2 meters and the encoder has 96 increments per wheel rotation, it is possible to transmit 9 channels or bits up to a speed of 135 k.p.h. between the wheel speed pulses. Towards higher speeds, it is possible at 150 k.p.h., 165 k.p.h., 180 k.p.h., 210 k.p.h., 340 k.p.h., and 300 k.p.h. to transmit one less channel in each case so that only three channels are available at 300 k.p.h. for transmitting additional information. The remaining channels are hence severed. So far, it has been tolerated that additional information in the severed part is available only below an associated limit speed. It is therefore appropriate to assign to the severed channels those pieces of information, which are not absolutely necessary for the operation of the motor vehicle (for example, comfort functions such as brake lining wear, etc.).

An object of the present invention is to disclose an arrangement with a wheel speed sensor, which does not necessitate managing without part of the additional information in determined driving situations.

### SUMMARY OF THE INVENTION

This object is achieved by such an arrangement in which the wheel speed sensor comprises switch-over means (10, 11) permitting to effect a change of the allocation of the additional information to the available channels by way of a mode switch-over.

The arrangement according to the invention satisfies the requirement of being able to poll determined status information depending on the vehicle state, irrespective of the driving speed.

In an operating mode determined additional information is associated with one or more fixed channels. It is suitable when the assignment of the information being transmitted to the individual channels is executed in conformity with hierarchic aspects.

The arrangement of the invention is used for the simultaneous transmission of wheel speed information and varying additional information in vehicles by employing so-called active sensors, meaning sensors that need to be fed with electric energy for their operation. It is preferred to employ these sensors in motor vehicles, in particular in motor vehicles with electronically controlled brake systems such as ABS, ESP, etc. The sensors of the invention may also be used for measuring angular displacements or position shifts where additional information shall be transmitted, such as in angular position sensors or travel sensors.

The invention proceeds such that according to defined status and/or control criteria, the coding format and/or the bit length of the status information is switched over with the objective of adapting the transmittable number of channels of additional information, said number varying with the driving speed (wheel rotational speed), to the temporary information requirement of the control system.

This adaptation is carried out by means of a device for mode switch-over comprised in the sensor. The operating mode of the sensor is switched over preferably quasi-continuously, for example constantly speed-responsively, for the adaptation. In particular, this is done in a way that the maximum possible density of transmittable information is reached.

Switch-over may be effected in response to one or more of the following criteria that are preferred according to the invention, with several criteria simultaneously being also allowed:

A) Selected driving conditions of the motor vehicle, especially those which can be derived by the wheel speed sensor itself such as wheel speed, standstill of the vehicle, magnitude of the angle of rotation or the number of pulses of the encoder wheel, direction of rotation,

B) Controlled by a timer, e.g. by means of a time pattern (e.g. timer and/or calendar), in particular in conjunction with an automatic switch-over of the sensor or switch-over triggered by the control device,

C) Request for switch-over by the control device,

D) change in value in one or more transmission channels for additional information, e.g. in the event of a change of a bit or a combination of bits of the additional information,

E) change of the magnetic field intensity at the wheel speed sensor, e.g. induced by air gap variation or magnet defects, especially when the limit value of an air gap variation is exceeded with dynamic deformation at a transverse acceleration of the vehicle,

F) signal variation at one or more additional signal inputs of the rotational speed sensor, for example, when a status bit changes, when a data word or a word sequence to be transmitted serially prevails at the input of the wheel speed sensor, or upon change of a signal frequency or Baud rate,

G) change of an internal electric operating mode of the wheel speed sensor, for example, when switching over from the initial mode to a control mode, or when it is detected that the supply voltage drops below a value.

The above-noted criteria thus permit switch-over of the transmission mode of the wheel speed sensor. In the simplest case, for example two or more transmission modes are provided which differ from each other only by the allocation of the additional information to the respective signal channels.

Where the objective is to transmit a digitally coded analog value such as the field intensity in the air gap by way of the signal channels, it may be expedient to transmit the analog test value, after switch-over into another mode, with a resolution increased compared to the standard resolution.

Further favorable embodiments of the invention become apparent from the following description of the Figures.

In the drawings,

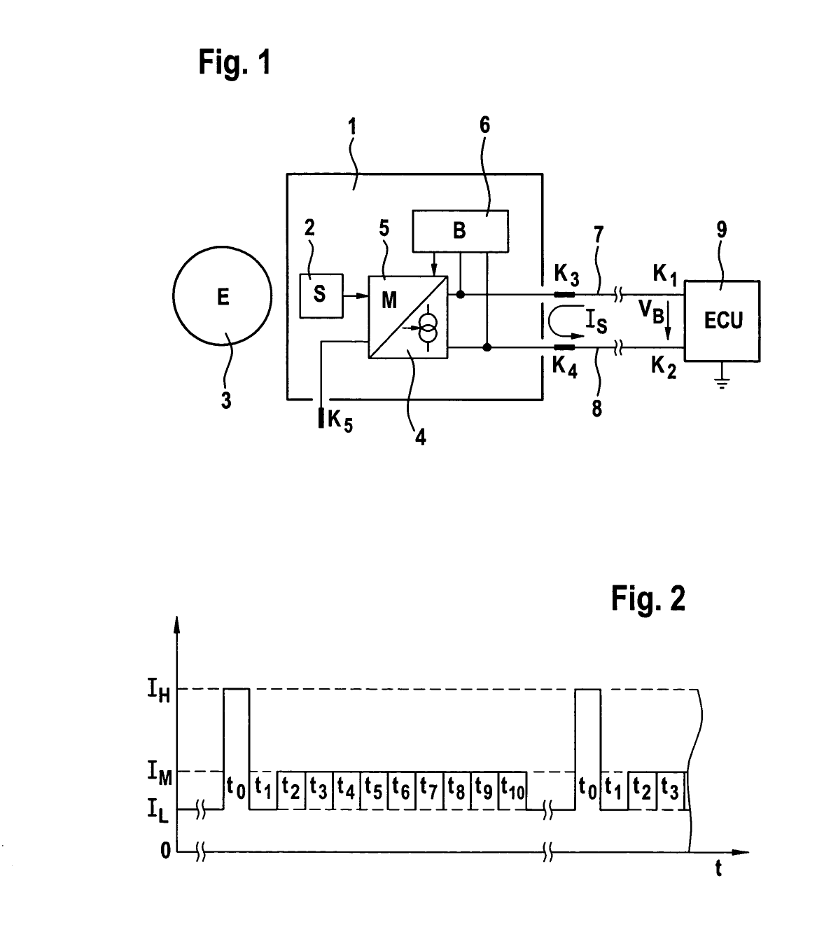

FIG. 1 is a schematic view of a sensor arrangement for detecting the wheel rotational speed according to the state of the art.

FIG. 2 shows a data protocol of an active wheel speed sensor according to the state of the art.

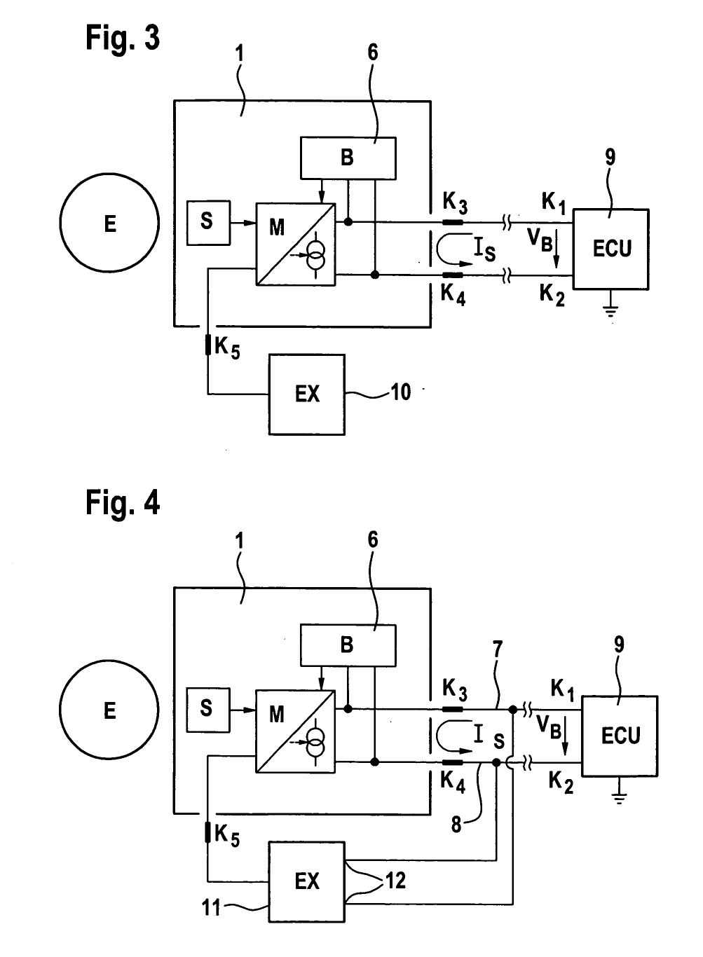

FIG. 3 is a schematic view of a sensor arrangement of the invention with an externally controlled protocol change.

FIG. 4 shows a sensor arrangement of the invention with an internally controlled protocol change.

The mode of operation of the above-mentioned international patent application WO 98/09173 will be explained in the following by way of FIG. 1. Sensor module 1 and electronic control device 9 (ECU) for controlling a motor vehicle brake system are interconnected by way of a two-wire conduit 7, 8 being additionally used for data transfer and for voltage supply to the sensor module 1. Operating voltage V_{B} applied to terminals K₁, K₂ of the control device causes a signal current I_{S} over conduit 7, 8, which is modulated by modulator 5 and current source 4 in accordance with the information being transmitted. To transmit the wheel rotational speed, an annular permanent-magnetically magnetized encoder 3 is connected with the wheel, said encoder being scanned by sensor element 2. A current signal is produced when the pole direction of the magnetic field sensed by the magneto-electric transducer 2 changes so that a periodic square-wave signal (FIG. 2) develops at a defined rotational speed, and the interval between the pulses of said signal depends on the rotational speed. In the pulse pauses between the rotational speed pulses, further current modulations may be provoked for the transmission of one or several pieces of additional information apart from the wheel rotational speed (additional information).

Encoder 3 may just as well be configured as a toothed wheel made of steel or a magnetized pulse wheel that is magnetically coupled by way of an air gap to the actual magneto-electric transducer 2 (e.g. magneto-resistive bridge) within the sensor 1.

To superimpose additional information, sensor module 1 comprises observation circuit 6 that is connected to signal conduits 7, 8. Observation circuit 6 receives information signals through conduits 7, 8 and decides in response to these signals about the acceptance or processing of the information, pulses or signals supplied by way of additional connection K₅. Observation circuit 6 acts also on modulator 5 and current source 4 for this purpose.

A per se known protocol for the transmission of sensor data to a control device can be seen in DE-A 199 11 774. This known protocol will be explained in the following by way of FIG. 2. In time period t₀ a signal pulse representative of an encoder transition is generated with the amplitude I_{H}. Upon expiry of time t₀, current I_{L}>0 will flow for the interval t₁. Subsequently, the additional signals described already hereinabove are modulated on the sensor signal. It is preferred that these additional signals are digitally coded in the shape of individual bits. 9 bits are transmitted in the illustrated example. When e.g. only status bit information such as ‘on/off’, ‘brake lining is worn/not worn’, etc., is transmitted, nine transmission channels are available. The individual bits transmitted are referred to as t₂ to t₁₀. Depending on whether state ‘1’ or ‘0’ is concerned, the pulses of the individual additional information will have the amplitude I_{M} or I_{L}. However, it is also possible and preferred in the invention to code the data according to the per se known Manchester Code, according to which the distinction between ‘1’ and ‘0’ is fixed by the rise or fall of a pulse edge rather than by the amplitude.

As mentioned already, the information being transmitted in the pauses of the wheel speed pulses may be of most different types. It is known to be possible to allocate one individual piece of status information to each bit. For example, ‘1’ at the position designated by t₂ will then be an indicator of the fact that the maximum allowable air gap has been exceeded. It is usual in vehicle industry to standardize the allocation of the individual bits to defined information so that e.g. wheel sensors of different makers may be interchanged. A first part of e.g. 5 bits (t2 to t6) from the available transmission range limited in practice to e.g. maximally 9 bits is used in order to transmit individual status signals according to a currently customary standard. The remaining bits t₇ to t₁₀ are used to transmit a digitized analog value having the word length of 4 bits. This analog value may e.g. be the magnetic air gap field intensity measured within the sensor. A sensor of this type would then have seven channels for information.

FIG. 3 shows in a schematic view an embodiment of a sensor with a switch-over means 10 for an externally controlled change of protocol. Preferably, the switch-over means is an external device, e.g. an autonomous warning device, a timer, or a limit value generator which executes switch-over when the criterion of an alert appears. Device 10 is connected to sensor module 1 by way of line K₅. Advantageously, a binary status signal is applied to k₅. Depending on the limit value generator, a ‘high’ level is applied to k₅ by device 10 and executes switch-over of the protocol for the duration of the critical warning situation, the fixed time span, the duration of exceeding of a limit value, etc. After switch-over into the switch-over mode, e.g. all available bits t₂ to t₁₀ are used for the transmission of the current air gap field intensity. This feature also allows the control device to pursue and, as the case may be, further evaluate the time variation of the air gap field intensity with an increased resolution.

When switch-over is effected in response to the wheel rotational speed, it is possible to constantly adapt the measurement resolution in the sensor to the transmittable number of bits. This way it is possible in the control device 9 to conclude the operating mode of the sensor in each case from an assessment of the received rotational speed signal.

According to another example for using the protocol switch-over of the sensor, a mode switch-over is initiated by a request from the control device. To trigger the switch-over of sensor 1, control device 9 decreases the operating voltage VB in a defined manner, especially corresponding to a pulse-shaped coded voltage pattern. The decrease can occur e.g. to a voltage below the minimum operating voltage of the wheel speed sensor. To this end, observation circuit 6 additionally comprises a decoding stage (not shown) that decodes the voltage pattern caused by the control device and induces the mode switch-over in response to this pattern. Device 10 may be dispensed with in this embodiment according to the example described herein. The method described is also appropriate for resetting externally controlled protocol changes, however, in particular also for the protocol control according to driving-dynamics requirements.

FIG. 4 shows a wheel speed sensor according to FIG. 3, however, with an internally controlled protocol change. An external signal generator 11, e.g. an additional sensor or signal memory with digital output, is connected to terminal K₅ by way of an electric conduit and, hence, inputs a longer bit sequence into sensor element 1, with the purpose that this information as an additional information to the wheel speed information is transmitted to the control device in a shortest possible time. The external signal generator 11 has for this purpose additional inputs 12 electrically connected to conduits 7, 8. Preferably, signal generator 11 may comprise in addition another observation circuit (not shown), the mode of operation of which generally corresponds to the mode of operation of the observation circuit 6 described hereinabove. Signal generator 11 initially detects the pulse-coded decrease of operating voltage V_{B} induced by control device 9. Sensor element 1 is this way urged by the control device 9 to send the signal generator message. As this occurs, switch-over by sensor element 1 is detected in the manner described hereinabove with respect to FIG. 3.

When it is required to transmit analog values at a resolution of more than 9 bits, the above-described arrangement allows a split-up of a converted analog value into two or more part words according to another preferred aspect. These part words are then, in particular consecutively, transmitted between the wheel speed pulses. The transmission is especially effective when the bit length of the part words and the production of the part words are constantly adapted to the available pause length for the purpose of a quickest possible data transfer.

In the example described hereinabove, switch-over of the protocol was initiated by the control device by decreasing the operating voltage of the sensor. In another embodiment, the protocol according to FIG. 2 is automatically controlled by sensor 1 in such a fashion that with switch-over of the protocol one or more bits in the protocol are used to signal to control device 9 which protocol pattern is just being used. Preferably, bits are used to display the currently used protocol pattern which lie at the beginning of a transmission sequence, e.g. in the periods t₂, t₃. As mentioned before, the bits transmitted at the start of a sequence are not cut off, not even at high motor vehicle speeds. A distinction between four different sensor modes (protocols) is possible when the bits t₂ and t₃ are used.

An operating mode is referred to in another embodiment, which allocates all available bits of the additional information to one single analog value so that said value is transmitted with a high resolution to the control device. This is expedient especially when the analog value represents the relative intensity of the magnetic field in the air gap. It is possible to sense dynamic variations of the air gap and use them to determine driving conditions in a brake control and/or driving dynamics control by a constant transmission of the currently converted analog value. The observation of the current air gap may also be used as an indicator of the transverse acceleration that acts on the wheel or the wheel bearing temperature. Further, it is possible to use the wheel sensor of the invention corresponding to a per se known side wall torsion sensor (Side-Wall-Torsion-Sensor, SWT), wherein a magnetic coding mounted on/in the side wall of a tire is scanned by a rotational speed sensor to measure the tire's torsion and/or the transverse acceleration.

In another favorable embodiment, the reversible protocol is used to transmit additional information obtained from the wheel bearing, such as vectorial force components, one after the other and in a shortest possible time (as described before) to the ECU by way of the external input K₅.

It may be suitable and expedient in a motor vehicle with several wheel speed sensors when each wheel speed sensor individually adopts or is assigned an operating mode, which is especially appropriate with respect to the local wheel speed.

Preferably, the maximum length of the employed data protocol, especially the number of bits, is so adapted to the discrimination of the encoder that always the full length of the data protocol can be transmitted in a bottom speed range of roughly 130 k.p.h.

In another preferred embodiment of an arrangement of the invention, the resolution of the encoder is increased to roughly 200 increments per rotation (for example, by doubling the usual number of 100 increments), and the maximum number of bit additional information is reduced to 5 bits.

In another preferred embodiment of the arrangement of the invention, the resolution of the encoder is reduced to roughly 50 increments per rotation, and the maximum number of the bit additional information is increased to 16.

1. Arrangement comprising one or more wheel speed sensors (1) and at least one control device (ECU), wherein the wheel speed sensor(s) is/are connected to the control device by way of a data interface (k1,k2,k3,k4) preferably composed of two electric current paths and used to transmit wheel speed information and additional information, wherein the wheel speed sensor includes means for sending rotational speed information via the data interface and means for sending additional information, and wherein the sensor includes a predetermined, however, optionally variable number of signal channels (t2 . . . t10) for the transmission of the additional information via the interface and each piece of information is allocated to a signal channel and/or a fixed number of signal channels,
characterized in that the wheel speed sensor comprises switch-over means (10, 11) permitting to effect a change of the allocation of the additional information to the available channels by way of a mode switch-over.

2. Arrangement as claimed in claim 1,
characterized in that each signal channel can transmit two states (e.g. ‘0’ or ‘1’).

3. Arrangement as claimed in claim 1 or 2,
characterized in that the mode switch-over is executed in response to the rotational speed.

4. Arrangement as claimed in at least any one of claims 1 to 3,
characterized in that the mode switch-over is executed in response to a time pattern.

5. Arrangement as claimed in at least any one of claims 1 to 4,
characterized in that the mode switch-over is executed according to the criterion of a request by the control device, in particular by modification of the sensor operating voltage by means of the control device.

6. Arrangement as claimed in at least any one of claims 1 to 5,
characterized in that the mode switch-over is automatically executed by the sensor.

7. Arrangement as claimed in at least any one of claims 1 to 6,
characterized in that the mode switch-over is executed in response to the measured magnetic air slot, in particular the field intensity in the air slot.

8. Arrangement as claimed in at least any one of claims 1 to 7,
characterized in that the signal channels are time windows which lie in the pulse pauses between consecutive wheel speed pulses, the intervals between the latter being speed-responsive.

9. Arrangement as claimed in at least any one of claims 1 to 8,
characterized in that the switch-over means changes the number of the signal channels transmitted in the pulse pauses, in particular in response to the length of the pulse pauses.

10. Arrangement as claimed in at least any one of claims 1 to 9,
characterized in that the bit length of a word of a digitized information being transmitted is increased by splitting the word into part words, by transmitting the individual part words one after the other or directly one after the other between the pauses of the wheel speed pulses, and by putting the part words together again within the control device to regain the original word.

11. Arrangement as claimed in claim 10,
characterized in that the number of the part words required when splitting up the words, or the fact per se that such split-up is made, is made contingent on which pause length can be used.

12. Arrangement as claimed in at least any one of claims 1 to 11,
characterized in that the mode switch-over takes place in dependence on the change of the signal state in a channel or in a group of channels (e.g. exceeding or falling below a value).

13. Arrangement as claimed in at least any one of claims 1 to 12,
characterized in that the mode switch-over takes place in dependence on an external input (k5) of the wheel speed sensor.

14. Arrangement as claimed in at least any one of claims 1 to 13,
characterized in that the mode switch-over takes place in dependence on an internal electric operating mode of the wheel speed sensor.

15. Arrangement as claimed in at least any one of claims 1 to 14,
characterized in that the electric energy supply of the wheel speed sensor takes place by way of the data interface.

16. Wheel speed sensor (1),
characterized in that said sensor comprises switch-over means as claimed in at least any one of claims 1 to 15.

17. Control device (ECU) with a receiving circuit for processing data that have been transmitted by way of the data interface (k1 . . . k4) of a wheel speed sensor in the arrangement as claimed in at least any one of claims 1 to 15.
